(19) United States
(12) Patent Application Publication
(10) Pub. No.: US 2010/0207375 A1
(43) Pub. Date: Aug. 19, 2010

(54) BOOK PRODUCT AND PAGES FOR THE SAME

(75) Inventor: Hermann Gruber, Muenchen (DE)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: COLLECTOBOOK GMBH & CO. KG, Muenchen (DE)

(21) Appl. No.: 12/678,950

(22) PCT Filed: Sep. 19, 2008
(86) PCT No.: PCT/EP08/62553

§ 371 Date: Mar. 18, 2010

(30) Foreign Application Priority Data
Sep. 19, 2007 (DE) 20 2007 013 093.7

(51) Int. Cl. B42D 1/00; B42F 13/00

(52) U.S. Cl. 281/21.1; 281/38; 402/79

(57) ABSTRACT

A book product is described comprising a plurality of sheets. Each sheet is provided with at least one binding preweakening pattern along at least one side parallel to the edge between straight lateral edges of the sheet. The binding preweakening patterns of sheets lying on top of one another are aligned with one another. An elastic binding device is arranged in the area of the binding preweakening patterns, the elastic binding device holding the sheets together. Further, a sheet for insertion into the book product is described. The sheets can be easily inserted into and removed from the book product.

The invention relates to a book product comprising a plurality of sheets. Further, the invention relates to sheets, in particular for insertion in the book product.

Known book products, such as stitched-together sheets with respective cover sheets, bundled sheets in folders, sheets in clamp binders, a large number of loose leaves in folders, archiving systems such as photo albums, are widespread and often used. What is disadvantageous with these book products is that they are difficult to handle, single sheets cannot be flexibly replaced or require a complex device which is not comfortable and practical for handling.

It is the object of the invention to provide a book product in which sheets can easily be inserted and sheets can easily be replaced.

According to the invention a book product is provided which comprises a plurality of sheets. Each sheet is provided with at least one binding preweakening pattern along at least one side parallel to the edge. The binding preweakening patterns of sheets lying on top of one another are aligned with one another, an elastic binding device which holds the sheets together being arranged in the area of the binding preweakening patterns.

The sheets can be folded over in the manner of a hinge along the binding preweakening pattern. The section of sheets lying on top of one another which is held together by the elastic binding device substantially remains in the compact initial position. In this way, the novel book product can easily be paged through. The elastic binding device can be easily removed so that several sheets can quickly and easily be compiled to a book. Replacement sheets or sheets to be newly added, for example, for collecting purposes, can easily be added to the existing sheets or again be removed.

The lateral edges of the sheet, i.e. the lateral edges extending transversely to the preweakening pattern are straight and smooth so that the binding device does not laterally engage with the sheets. This supports the easy and simple insertion and removal of sheets into or, respectively, from the book product.

An important application is the design of a sheet as a postcard. The sheet then has the format of a postcard as accepted by the postal authorities for sending within the postal area, both within the national postal area and the foreign postal area. In addition to an area for the postage stamp, the sheet also has an address area as well as a usable area to which information, texts, logos, images etc. can be applied. In an edge area along the long side or the broadside, a preweakening line is formed so that this sheet is suitable to be received in the book product described. Sheets in the form of postcards can thus be compiled and stored as a book product. For collectors who collect such sheets or postcards thus a comfortable possibility is offered to compile sheets in order of choice or in an order predetermined by a collection system, to remove collected sheets from the book product, to replace them by other sheets, etc. The novel postcards bound in this way into the book product can easily be paged through and can be handed over, shown, sold or distributed to potential customers in a comfortable way or used otherwise. It is also possible to use sheets in the format of postcards not in connection with the described book product but to collect them loosely or to store them in a postcard box for collecting purposes. In this way, with the aid of the novel postcard a new field of application is also created for the postal industry since by way of this postcard an interesting field of activity is opened up for collectors.

According to a further aspect of the invention, a sheet, in particular for insertion in the book product, is specified.

Embodiments of the invention are explained with reference to the drawings.

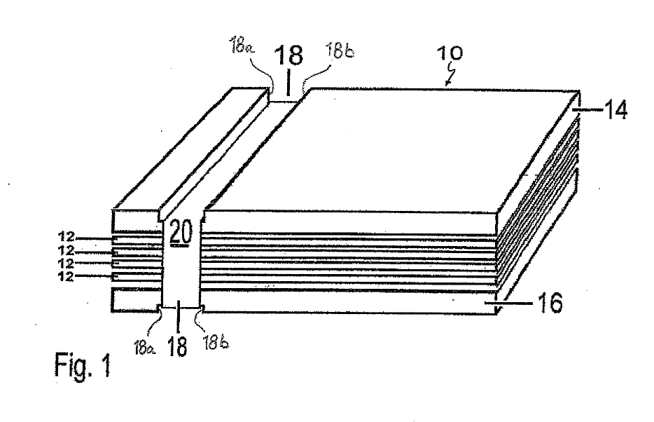

FIG. 1 shows a perspective view of the book product in the state of rest.

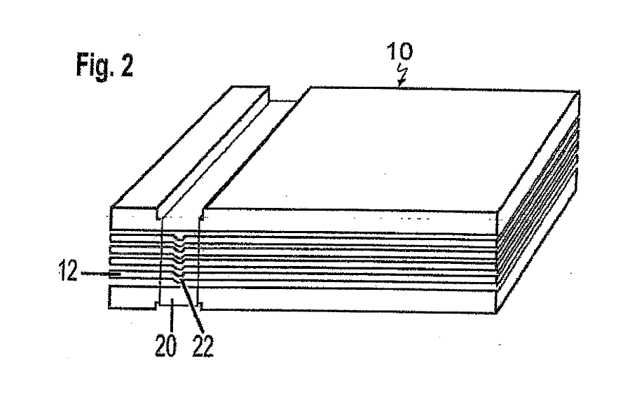

FIG. 2 shows the book product according to FIG. 1 with binding preweakening lines.

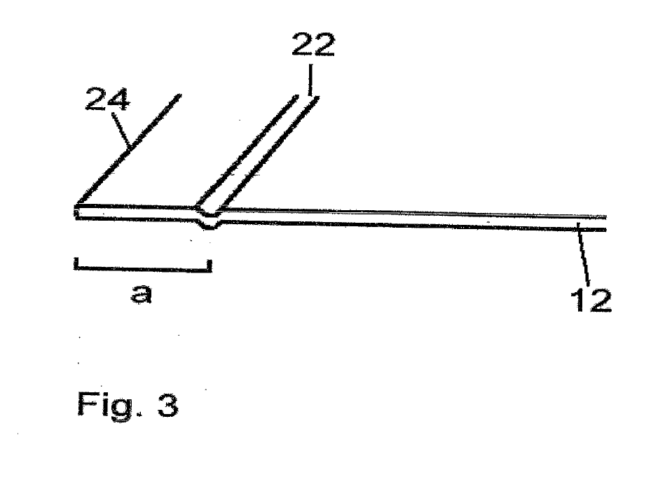

FIG. 3 shows a sheet with a binding preweakening line.

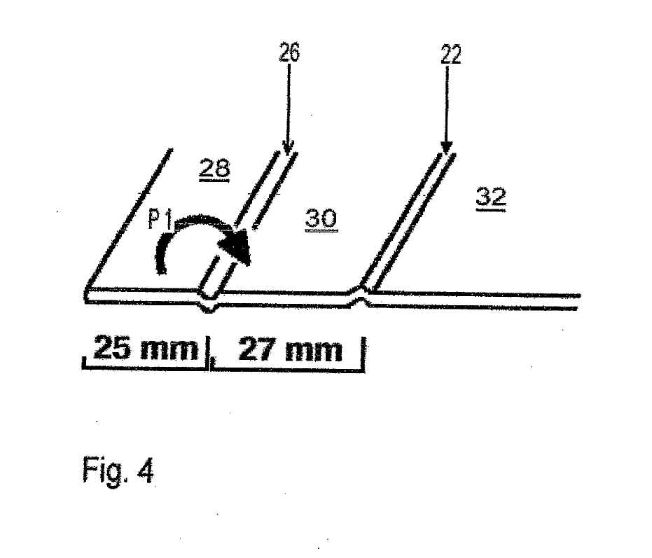

FIG. 4 shows a sheet with a binding preweakening line and a folding preweakening line.

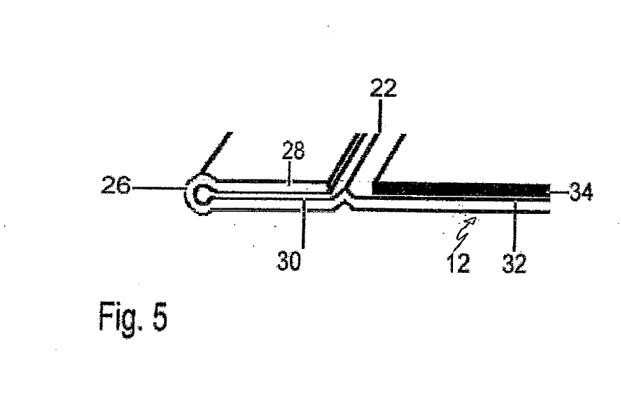

FIG. 5 shows the sheet according to FIG. 4 with folded-over sheet section.

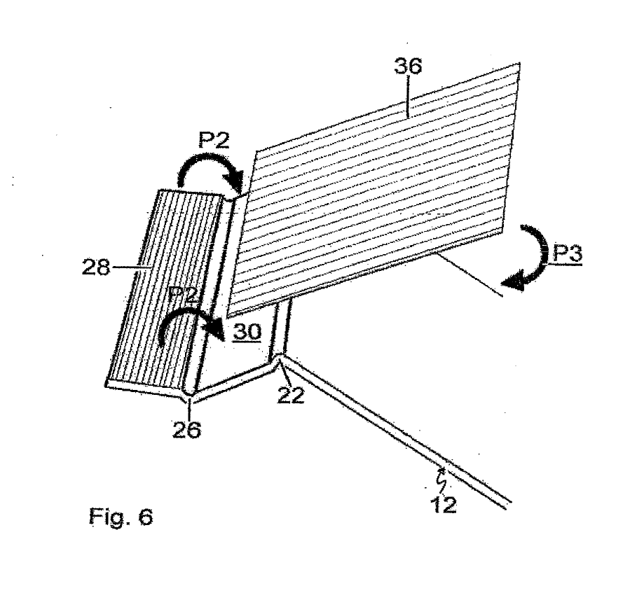

FIG. 6 shows a sheet with glued-in insertion element.

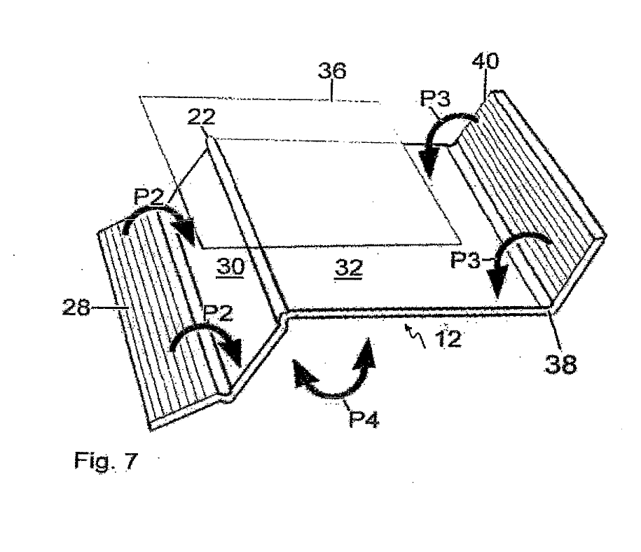

FIG. 7 shows a sheet with two folding sections.

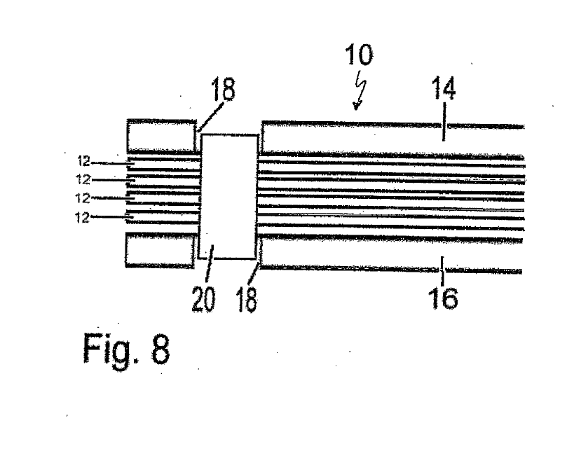

FIG. 8 shows a side view of the book product with elastic binding device.

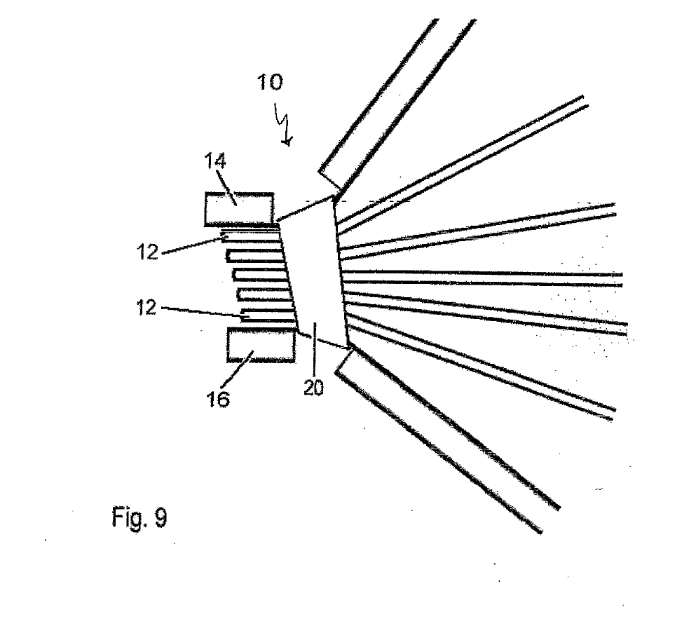

FIG. 9 shows a side view of the book product in the opened-up state.

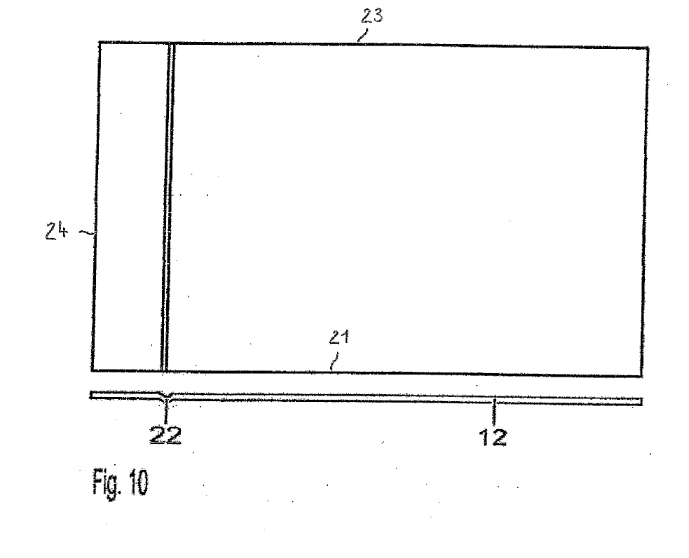

FIG. 10 shows a top view of a standard sheet with a binding preweakening line.

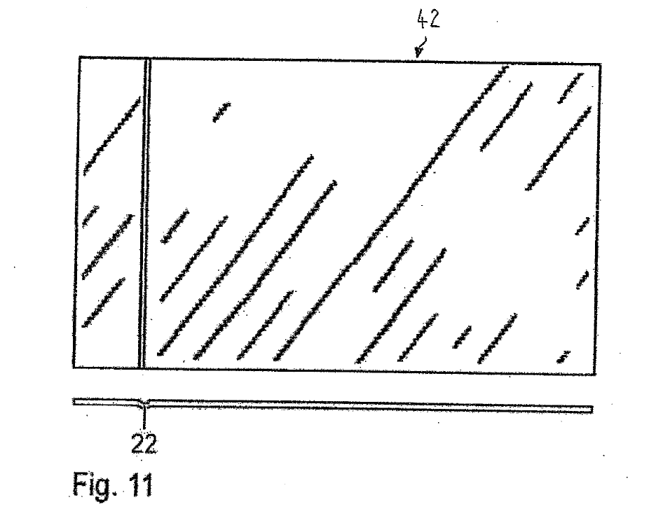

FIG. 11 shows a single sheet of transparent plastic material which can be written on.

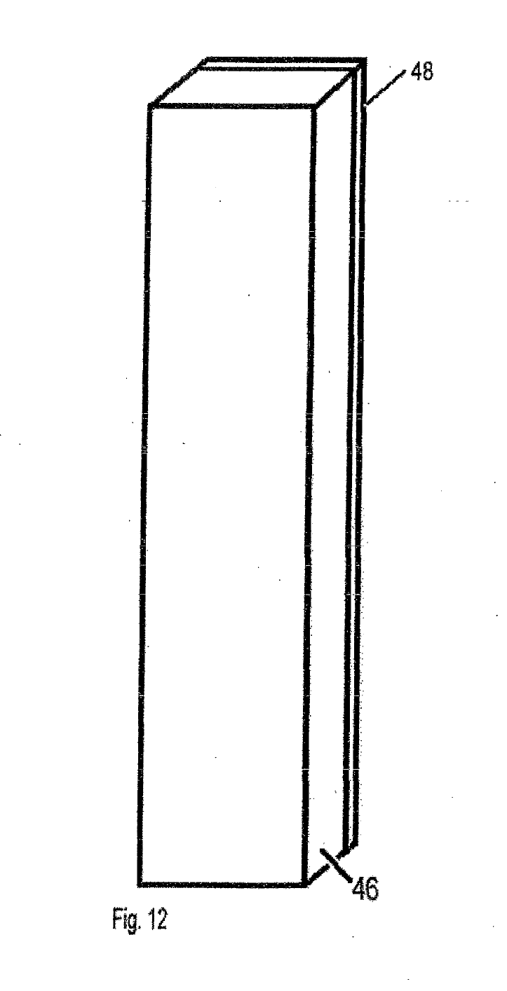

FIG. 12 shows a spacer.

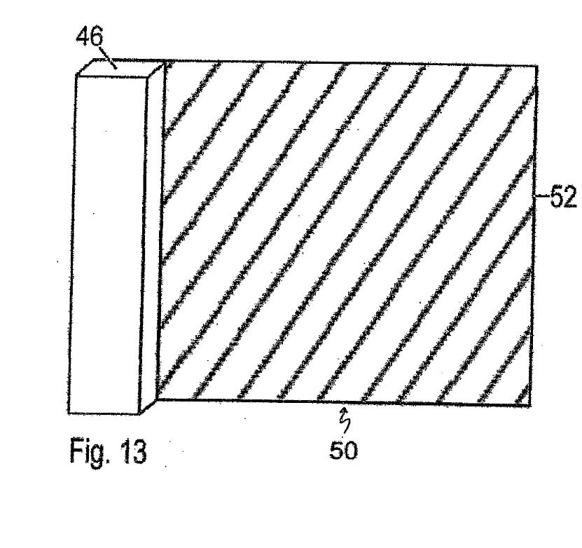

FIG. 13 shows a sheet with spacer.

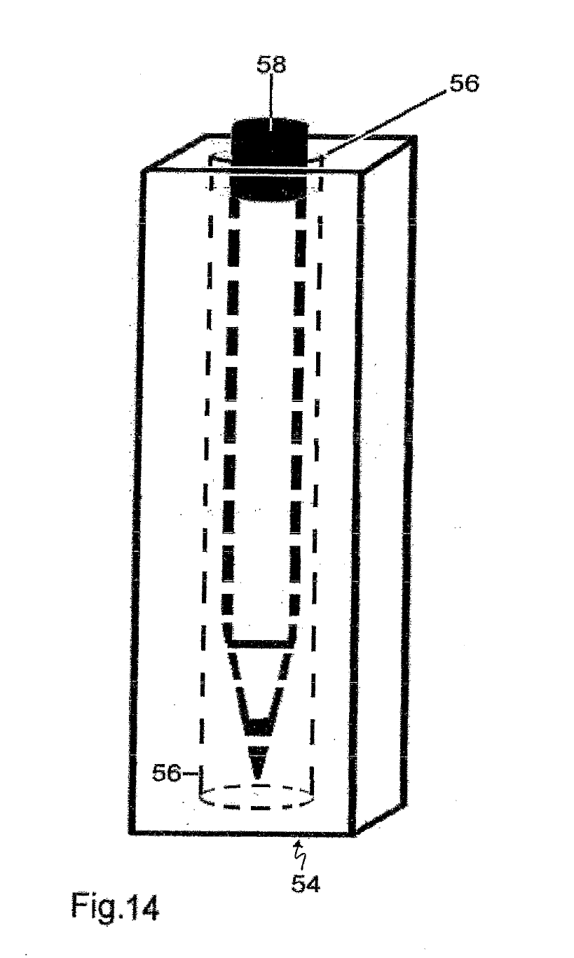

FIG. 14 shows a spacer with a pin received in a drill hole.

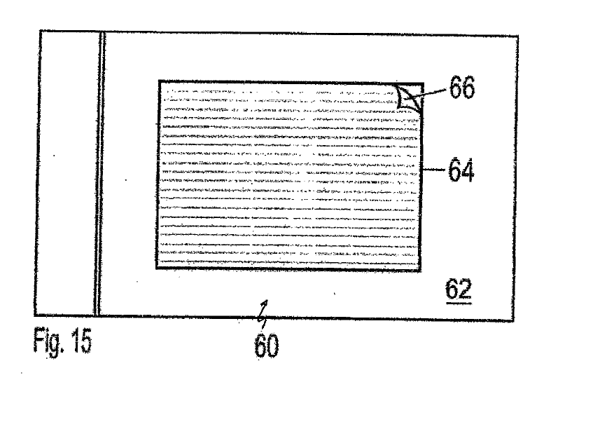

FIG. 15 shows a sheet with a double adhesive film in the usable area.

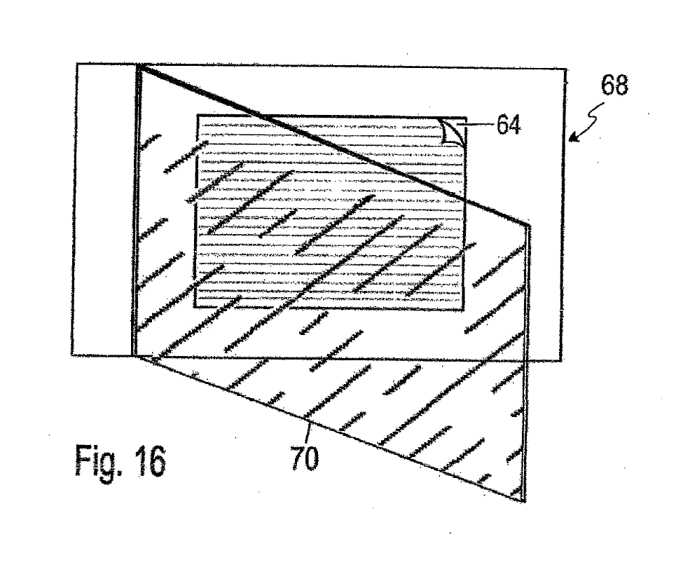

FIG. 16 shows the sheet according to FIG. 15 with additional separating sheet.

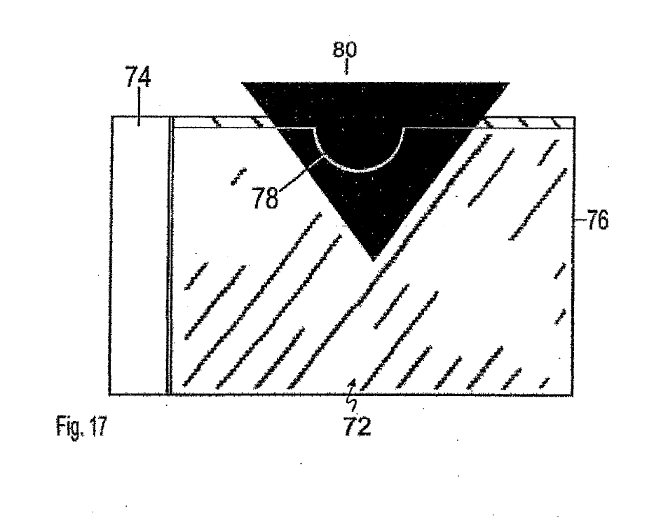

FIG. 17 shows a sheet with a pocket.

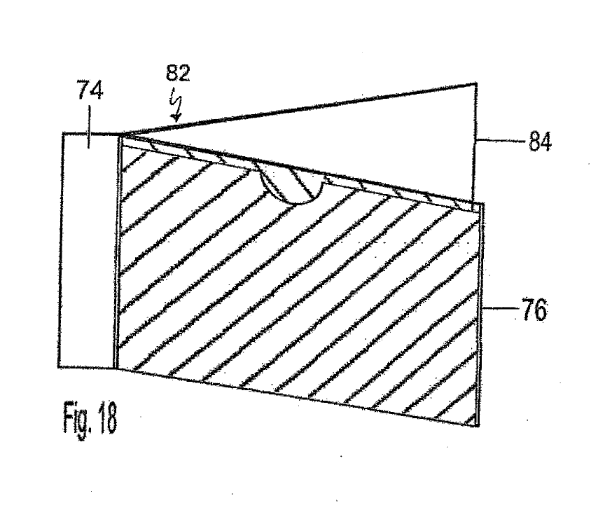

FIG. 18 shows a sheet with a pocket and additional white paper.

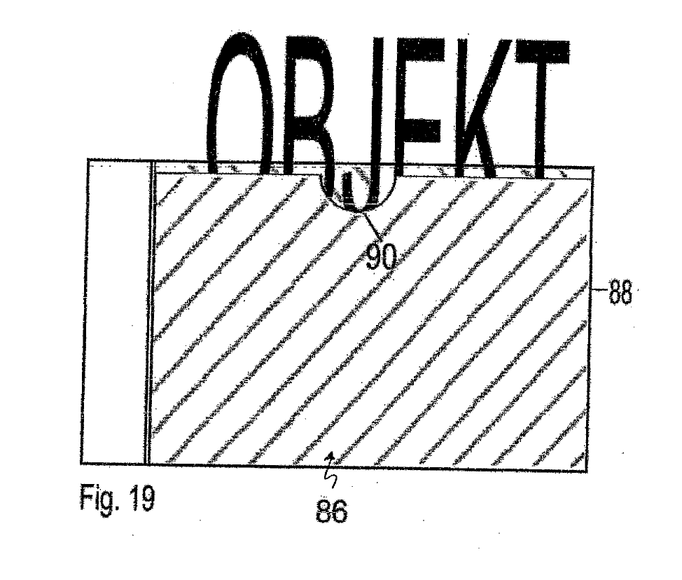

FIG. 19 shows a sheet with opaque pocket.

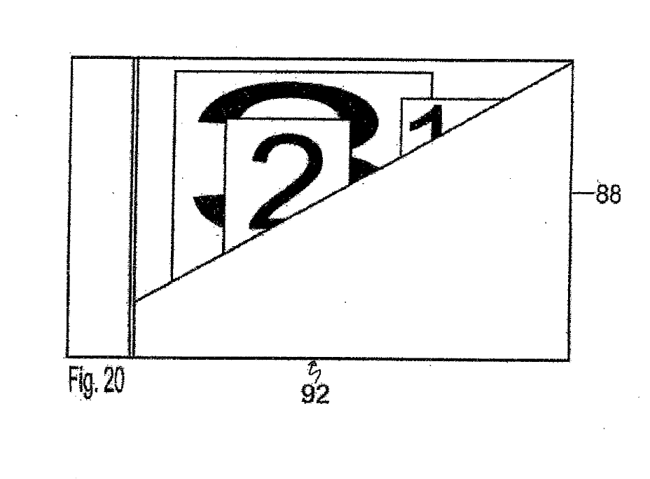

FIG. 20 shows a sheet with a diagonally cut pocket.

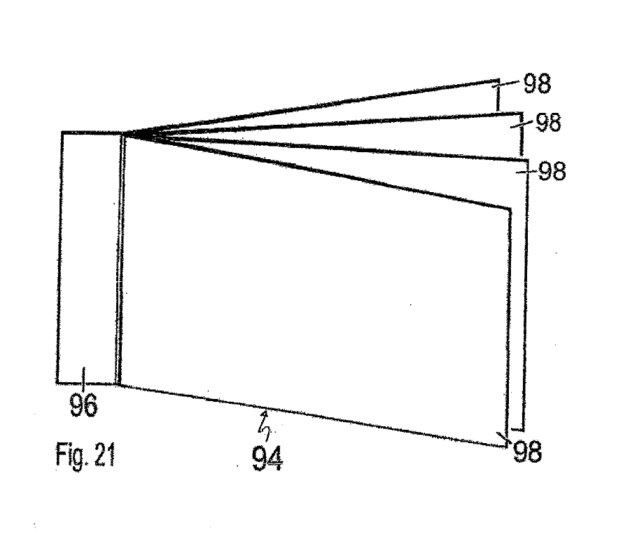

FIG. 21 shows a sheet formed as a booklet.

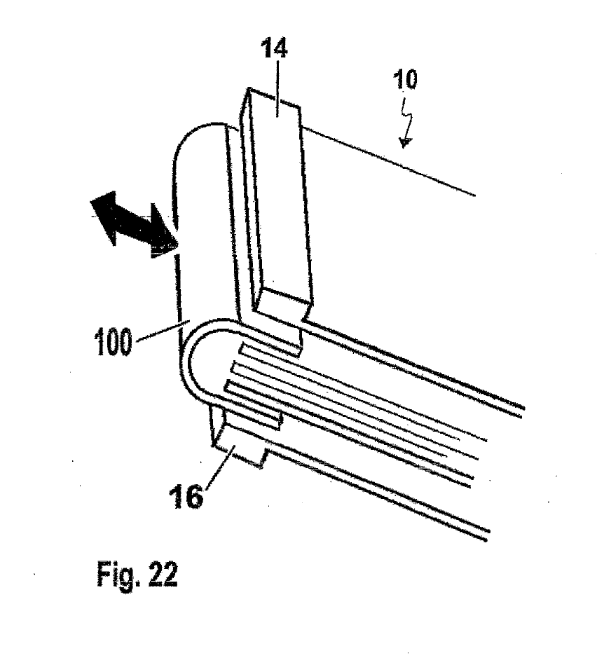

FIG. 22 shows a book product with a spine which can be written on.

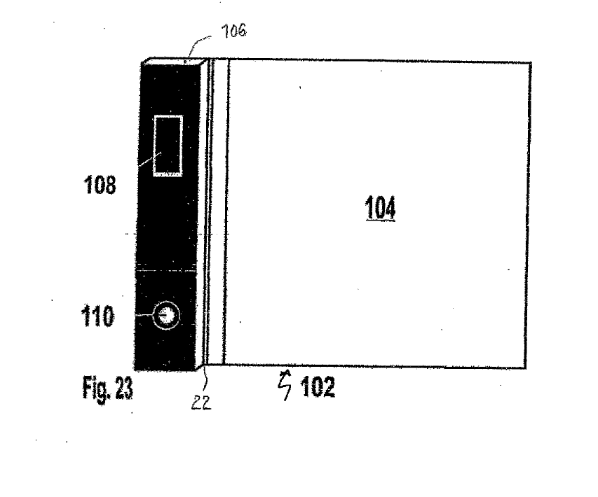

FIG. 23 shows an embodiment of a sheet with electronic paper.

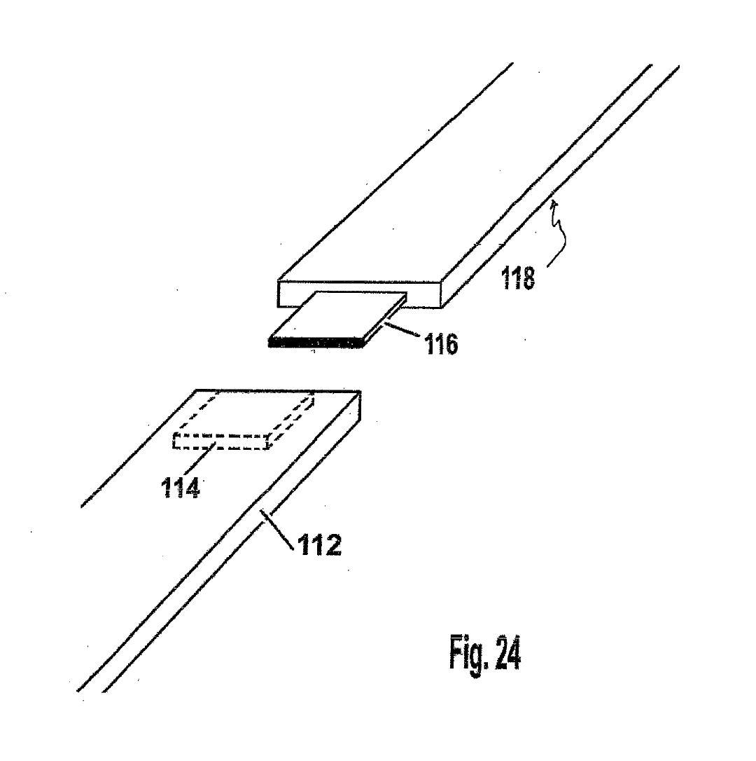

FIG. 24 shows a spacer with electric elements.

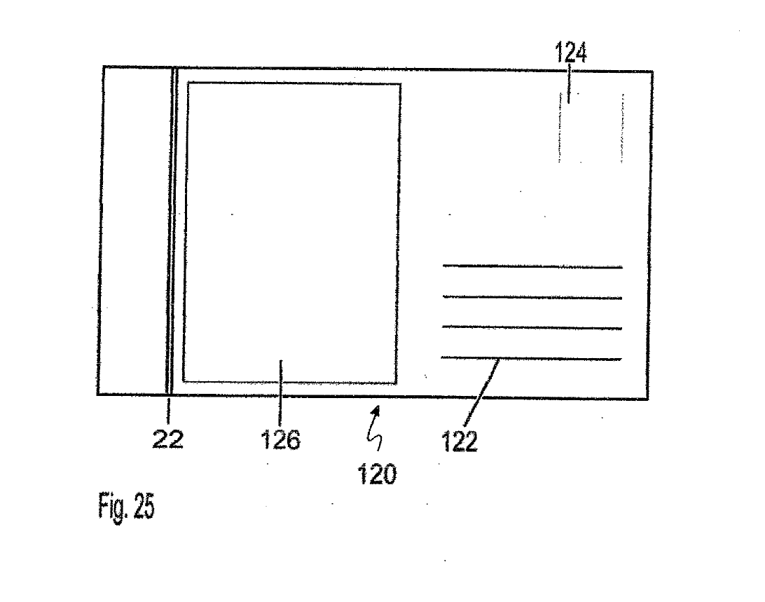

FIG. 25 shows a sheet formed as a standard postcard.

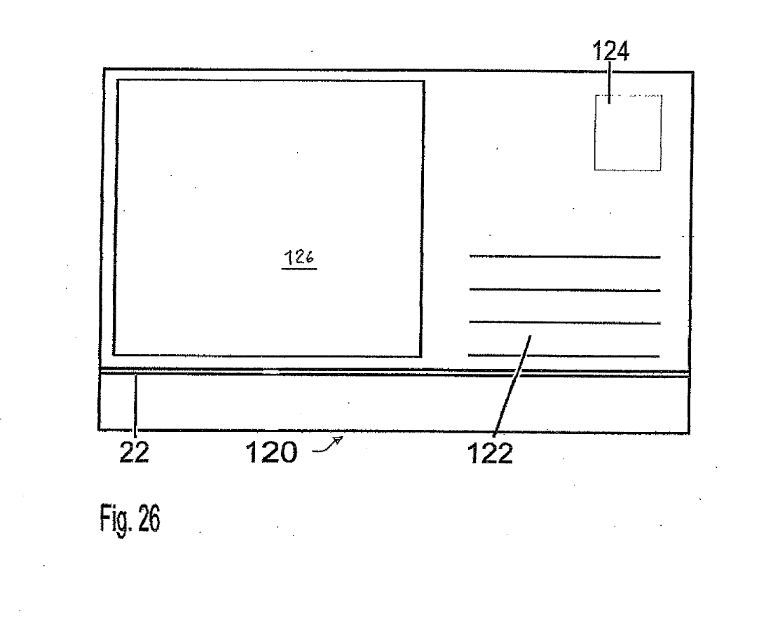

FIG. 26 shows a modification of the postcard with a preweakening line extending along the longer side.

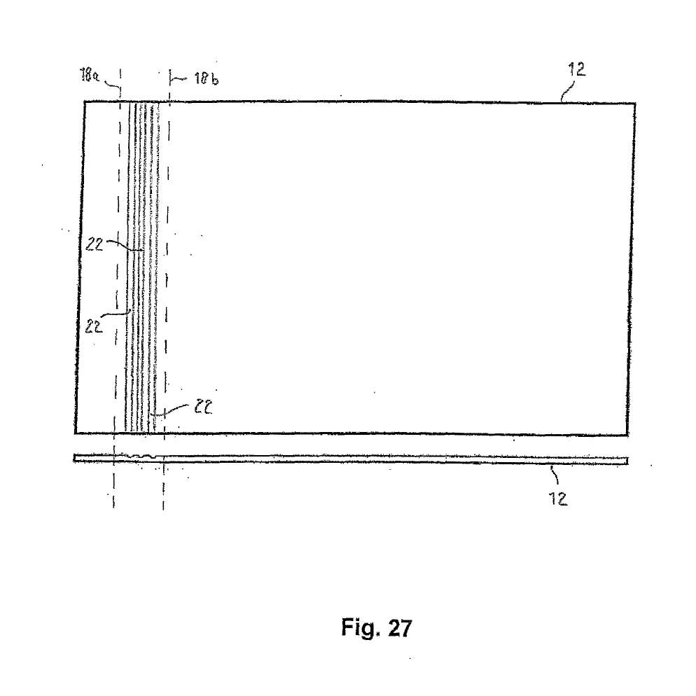

FIG. 27 shows a sheet with a plurality of preweakening lines.

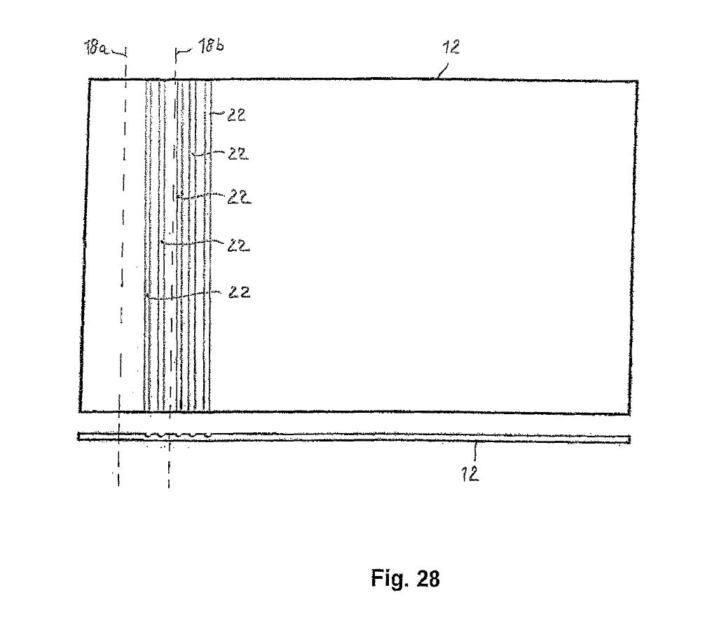

FIG. 28 shows a sheet with preweakening lines within and outside the boundaries of the binding device.

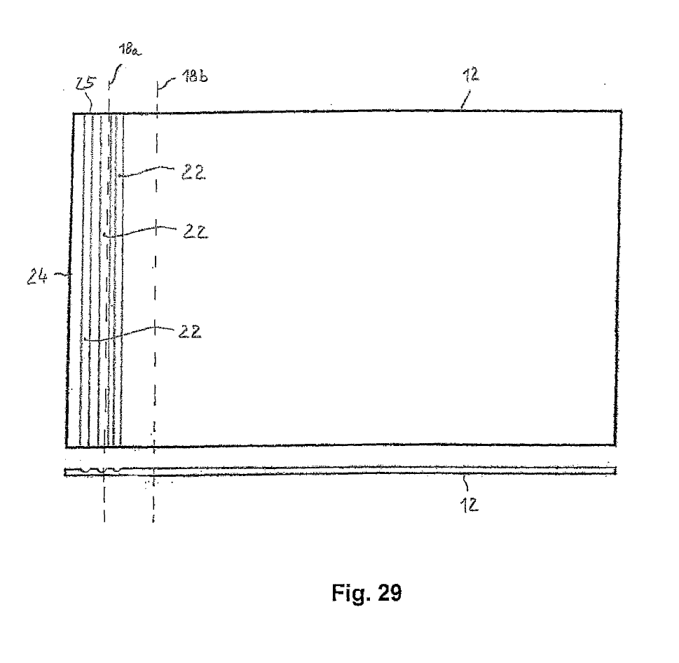

FIG. 29 shows a sheet with preweakening lines near the spine.

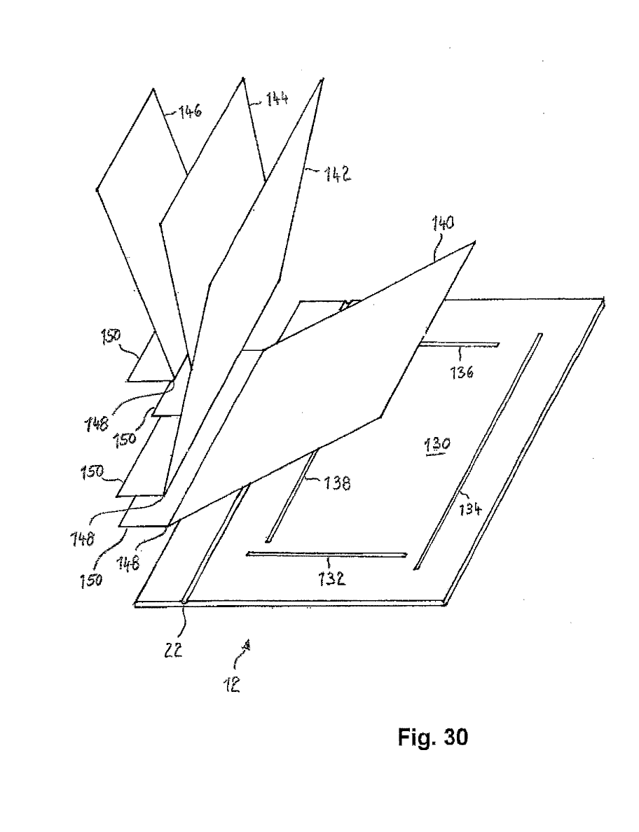

FIG. 30 shows a sheet with insertable sheets.

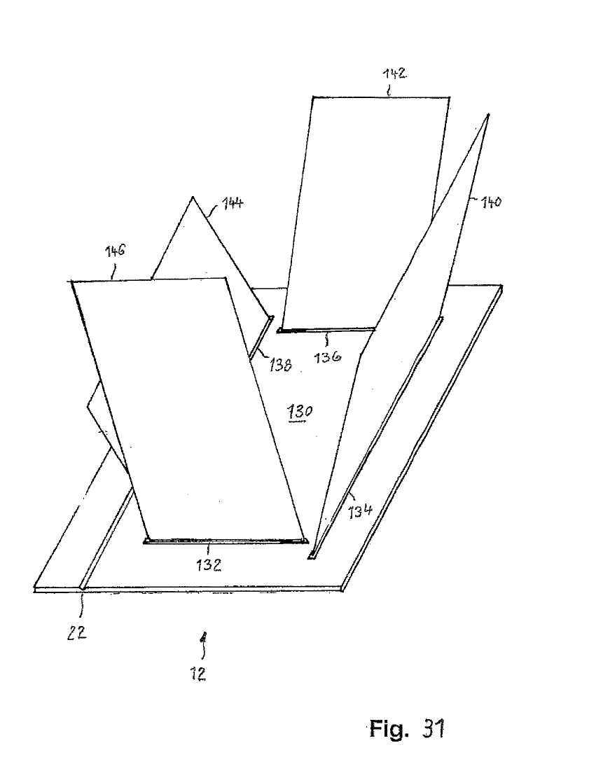

FIG. 31 shows the sheet according to FIG. 30 with inserted sheets.

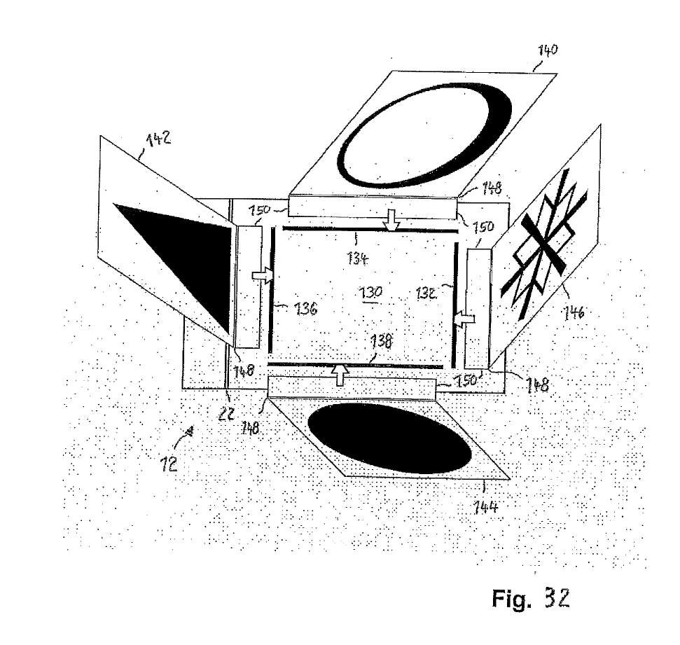

FIG. 32 shows a top view of the sheet according to FIG. 31.

FIG. 1 shows a book product, generally referenced with the numeral 10, in a non-opened state. The book product 10 has an upper book cover 14 and a lower book cover 16, between which single sheets 12 are arranged. The book covers 14, 16 are generally made of a stronger material than the single sheets 12 and have a broad binding groove 18 each, which, within walls or edges 18a, 18b, receives an elastic binding device 20, such as a rubber band. The elastic binding device 20 holds the book covers 14, 16 as well as the single sheets 12 together. Due to the elasticity of the binding device 20, the number of the sheets 12 and thus the thickness of the book product 10 can considerably vary, nevertheless the book product 10 being kept in a stable state both when closed or opened up. Instead of a binding groove 18, also a projecting structure can be used which defines projecting walls or edges 18a, 18b, within which the binding device 20 is received.

FIG. 2 shows the book product 10 according to FIG. 1 (identical reference signs identify identical or at least substantially similar parts in the following), the binding device 20 being transparent and providing an uninhibited view of binding preweakening lines 22 of the single sheets 12. The binding preweakening lines 22 of the sheets 12 stacked on top of one another are aligned with one another and are located in the area of the elastic binding device 20. Along the binding preweakening line 22, which runs parallel to the closest lateral edge of the respective sheet 12, the respective sheet 12 can be deflected as with a hinge, while nevertheless being held together with the book covers 14, 16 and the further sheets 12 in this area of deflection by the elastic binding device 20. When opening up the book product 10, the flexible elastic binding device 20 creates a hold-down force so that when the sheets 12 are released the initial state in which the sheets 12 and the book covers 14, 16 are compactly held together is restored for the book product 10.

FIG. 3 shows a sheet 12 with a binding preweakening line 22 which is formed as a groove. This groove is, for example, embossed by way of an embossing operation, the material of the sheet being compressed or bulged out. In this way some kind of a hinge is formed which allows to fold the sheet along the binding preweakening line 22 and thus to enable a book-like opening up of a plurality of sheets 12. The position of the binding preweakening line 22 is of considerable importance for a specific application. When a postcard which can be sent via different national postal systems is used as a sheet 12, then the binding preweakening line 22 must not interfere with the processing of the sheet as a postal item. Therefore, the binding preweakening line 22 is arranged at a distance a between 22 and 28 mm, preferably in the range between 24 and 26 mm, from the edge 24 of the sheet 12. As in the illustrated case, the preweakening line 22 can extend along the narrow side of the rectangular sheet 12. However, it is likewise possible that the preweakening line extends along the broader side. It has shown that given such a positioning of the binding preweakening line 22 a problem-free sending and a problem-free processing by national postal systems is possible without there being any interferences. In other applications, the preweakening line 22 can have a distance from the edge 24 of up to half the length or width of the sheet 12 at most. The lateral edge of the sheet 12 which is perpendicular to the edge 24 and to the preweakening line 22 and the lateral edge opposite thereto extend in a straight and smooth manner so that the binding device 20, such as in the form of a rubber band, does not positively engage with the sheets 12. In this way, sheets 12 can easily be inserted between sheets 12 already present in the book product 10 or, respectively, be removed therefrom without being impeded by the elastic binding device 20 during the insertion and removal movement.

FIG. 4 shows a further modification of a sheet 12 which can be used for the book product 10. In addition to the binding preweakening line 22 the sheet 12 comprises a folding preweakening line 26. This can again be realized in the form of a groove by an embossing process. For attaining the functional condition of the sheet 12, the section 28 at the left edge is folded over in accordance with the arrow P1 along the folding preweakening line 26 so that the section 28 comes to rest on the binding section 30 to the left of the binding preweakening line 22. The binding section 30 is the section which is located in the area between the closest edge of the sheets 12 and the binding preweakening line 22. After folding, the distance between the binding preweakening line 22 and the left edge of the sheet 12 which is formed by the folding preweakening line 26, is again in the range as indicated in FIG. 3. The section 28 typically has a width between 22 and 28 mm, preferably between 24 and 26 mm.

The folding of the edge section 28 can fulfill a distance function. When relatively thick materials, such as botanical material, are applied to the relatively large usable surface 32 of the sheet 12, then separate spacers would be necessary between the adjacent sheets in order to avoid that the sheets in the book gape open. By folding the section 28 which then rests on the binding section 30, a reinforcement in the cover is obtained for the respective sheet 12 in the area in which the elastic binding device 20 holds the various sheets 12 together. As a result of this distance function of the folded section 28, the possibility of paging through the entire book product 10 is still guaranteed.

FIG. 5 shows a sheet 12 in which an archiving material 34 of about the same thickness as the sheet 12 is applied to the usable surface 32. In the folded-over state of the section 28, which then rests on the section 30, the height of the sheet 12 in these sections 28, 30 is about as high as in the area of the usable surface 32 so that—with an equal height—the sheet 12 can still be turned over well.

A further function of the folding preweakening line 26 is the additional fixing of insertion elements. FIG. 6 shows an example thereof. The respective sheet 12 comprises a binding preweakening line 22 and a folding preweakening line 26. The section 28 between the left edge and the folding preweakening line 26 is provided with an adhesive material, e.g. a double adhesive tape. Upon folding along the arrows P2, an insertion element 36, for example, a transparent insertion sheet 36 or a collecting bag (not illustrated) is simultaneously glued in and thus fixed to the sheet 12. This offers, for example, the possibility of gluing in transparent glassine bags, glassine sheets or other foils for protecting specific materials or illustrations as well as data carriers on foil basis which can be turned over so that they can also be viewed or labeled from the back. If necessary, the section 30, too, can be provided with an adhesive surface, e.g. a double adhesive tape. The insertion element 36 can be turned up, as indicated by the arrow P3.

FIG. 7 shows a further embodiment of a sheet 12 which is a development of the sheet 12 according to FIG. 6. In the area to the left of the binding preweakening line 22, the embodiment corresponds to the one according to FIG. 6. In addition, following the usable surface 32 of the sheet 12 a further folding preweakening line 38 is provided about the longitudinal axis of which an edge section 40 can be folded along the arrows P3. The edge section 40 is provided with an adhesive layer, e.g. a double adhesive tape, which after folding fixes the insertion element 36 to the usable surface 32. By folding the edge section 40, a distance function is fulfilled so that particularly thick materials which rest on the usable surface 32 are protected. It can also be provided to fix a first insertion element 36 by the edge section 28 and to fix a further insertion element by the edge section 40. Both insertion elements then lie on top of one another, this resulting in further advantages.

FIG. 8 shows a side view of the book product 10. The elastic binding device 20 is embedded in grooves 18 of the upper book cover 14 and the lower book cover 16, respectively. As an elastic binding device 20, a specific rubber band can be used which is flexible enough to be manually removed from the binding recess formed by the grooves 18 so that sheets 12 can be removed, replaced or additional sheets 12 can be inserted. As a binding device 20 also a plurality of rubber bands can be used so that an adaptation to the thickness of the book and to the binding force is possible. The book covers 14, 16 can be made of cardboard material, plastic material or textile material. With the aid of the flexible binding device 20 a few sheets 12, for example three to four sheets and up to 80 sheets or more can be bound for the book product 10. As an alternative to the groove 18, also projecting holding elements can be provided as a holding device for the elastic binding device, which holding elements project outwardly from the book covers 14, 16 and prevent a displacement of the rubber band.

FIG. 9 shows the book product 10 in an opened up state. As a result of the used binding type with the elastic binding device 20, the block with the sheets 12 can “yield” and displace itself internally, as a result whereof easy paging even through a large number of sheets and also of thick sheets which weigh up to 250 g is made possible. After paging, the block of sheets again assumes the initial shape because of the elasticity of the binding device 20.

FIG. 10 shows in a top view and in a side view a standard sheet 12 with a binding preweakening line 22. As a material usually paper, cardboard, plastic is used, as well as all other materials which are suitable for applying the binding preweakening line, such as textile flocked and coated papers, metal foils, glassines, wrapping tissue and transparent materials. Typical paper weight ranges go from 60 g to 280 g, preferably in the range between 80 g and 200 g. For other materials, the thickness is in the range between 1 mm and 5 mm, preferably between 1 mm and 3 mm. The binding preweakening line 22 can have different shapes. For example, the binding preweakening line 22 as well as the other preweakening lines can be designed as an embossed groove. In cross-section, this groove can be designed in a V-shaped manner, semi-circular, rectangular or in the form of a semicircular arch. As a preweakening line, also a perforation line with circular or slot-like apertures can be provided, which partly or completely penetrate the material of the sheet 12. The sheet 12 has a rectangular or square shape. The lateral edges 21, 23 extend in a straight and smooth manner so that the binding device 20 does not laterally engage with the sheet 12 in a positive manner, and the sheet can easily be inserted into the book product 10 or again be removed therefrom. As there are no lateral recesses or notches in the lateral edges 21, 23, also the production and the prior use of such sheets 12 in printing processes are simplified.

FIG. 11 shows a single sheet 42 made of transparent plastic material which can be written on. This sheet 42 can advantageously be used to apply information thereto relating to the sheet lying underneath which is visible through the transparent plastic material.

FIG. 12 shows a spacer 12 which is inserted in the area of the binding device 20. On its rear side, the spacer 46 is provided with a double adhesive tape 48. The spacer 46 is used when a particularly thick material has been glued on one side of a sheet 12. As a result of its thickness which is adapted to the material glued-on, the spacer 46 prevents that the glued in materials do not open up the book block in a wedge-shaped manner.

FIG. 13 shows a sheet 50 comprising the spacer 46, on the rear side of which a usable sheet 52 is glued. A relatively thick material which corresponds to the thickness of the spacer 46 can be glued on the usable sheet 52. The usable sheet 52 typically consists of paper or cardboard.

FIG. 14 shows a spacer 54 with a drill hole 56. A pin 58 is inserted into the drill hole 56, which pin can be pulled out from the open side of the drill hole 56.

FIG. 15 shows a sheet 60 which is provided with a double adhesive film 64 in its usable area 62. After removing a protecting film 66, various materials can be fixed on the double adhesive film 64.

FIG. 16 shows a sheet 68 which in addition to the sheet 60 according to FIG. 15 is further provided with a transparent separating sheet 70 which can be written on and is used for the protection of the materials applied to the double adhesive film 64. The separating sheet can likewise be opaque.

FIG. 17 shows a sheet 72 in which at a section 74 which is located in the area of the elastic binding device 20 a pocket 76 is fixed. The pocket 76 is closed at three sides and is open at the top and has a recessed grip 78. A material 80 can be inserted into this pocket. Preferably, the pocket 76 is made of a transparent material, for example, foil material. The section 74 consists of cardboard or paper.

FIG. 18 shows a structure of a sheet 82 similar to the one according to FIG. 17. Behind the pocket 76 fixed to the section 74, a sheet 84 of white paper is joined to the section 74 so that the object inserted into the transparent foil pocket 76 is more visible against the white background.

FIG. 19 shows a sheet 86 similar to the one according to FIGS. 17 and 18, however an opaque pocket 88 is used that is closed at three sides, is open at the top and is provided with a recessed grip 90. The pocket 88 serves for storing flat objects.

FIG. 20 shows an embodiment similar to the one according to FIG. 19, however the pocket 88 is diagonally cut so that objects inserted into the pocket 88 are partly visible for this sheet 92.

FIG. 21 shows a sheet 94, in which at a section 96 which is arranged in the area of the elastic binding device 20, several usable sheets 98 are attached. The entire sheet 94 forms a booklet which is inserted into the elastic binding device as a whole. The booklet can be both printed and unprinted.

FIG. 22 shows a book product 10 in which a spine 100 which can be written on and which is bent into a U-shape is inserted into the area of the elastic binding device 20 between the upper book cover 14 and the lower book cover 16. In this way, the book product 10 can be provided with a title and can be better archived.

FIGS. 23 to 24 relate to the application of electronic paper for the book product. Electronic paper usually has the thickness of normal paper and can be changed in its surface color with the aid of electric pulses, or with the aid of electric pulses signs, images, texts can be displayed in the manner of a screen of a PDA or a flat screen.

FIG. 23 shows a sheet 102 in which a section with the usable surface is formed as an electronic paper 104. The electronic paper 104 is joined to a spacer 106 which receives a chip 108 in a recess. This chip 108 can be a digital processor that receives and sends information and controls the electronic paper 104 with the aid of electronic pulses in order to display signs thereon. Further, in a recess a battery 110 with an ON/OFF switch is arranged. The battery 110 supplies electric current to the chip 108 and the electronic paper 104.

FIG. 24 shows an example of a spacer 112 in which an electric contact 114 is embedded, which can receive the electric connector 116 of a USB stick 118.

FIG. 25 shows an important application in which the sheet is formed as a standard postcard 120. In addition to the standard format of this postcard 120, the preweakening line 22 is provided in the binding area. The postcard 120 comprises on the front side, as known per se, an address area 122 and a postage stamp area 124. In a front-side usable area 126, interesting information, texts, illustrations etc. for collectors can be provided. The back of the postcard 120 can also comprise the rear side of the areas 122 and 124 as a usable area.

FIG. 26 shows a modification of the postcard 120, the preweakening line 22 extending along the broadside of the postcard 120. The usable area 126 on the front then has the design shown in FIG. 26. It is also possible to provide a postcard with two preweakening lines 22, in which one preweakening line 22 extends along the broadside according to FIG. 26. The user himself/herself can then decide how he/she arranges the postcard 120 in the binding area of the book product. In this case, the binding device 20 holds together sheets with different formats. This modification can also be used for the other sheets illustrated in the preceding Figures.

The examples mentioned can comprise many modifications. For example, the elastic band used for the binding device 10 can be printable and produced in different colors. The different sheets which are written on can be treated mechanically differently for example by embossing, punching, stamping, embroidering.

The book product 10 can be manufactured in many formats, wherein given larger formats care is taken that the book covers are reinforced such that they do not buckle as a result of the tension of the binding device, for example the tension of the elastic band, and largely remain planar. For example, the covers can be reinforced by stable plastic plates or metal rails.

FIGS. 27 to 29 show further modifications of sheets 12 in which the number of binding preweakening patterns 22 and/or their position on the respective sheet 12 is varied. In FIG. 27, three preweakening patterns 22 are illustrated, which all lie within the boundaries of the binding device 20, namely within the projected left edge 18a (i.e. left boundary line of the binding device 20) and the projected right edge 18b (i.e. right boundary line of the binding device 20) of the binding groove 18 (see FIG. 1) which receives the binding device 20.

When turning over the sheet 12 in a book product 10, the entire deflection angle of the sheet 12 is distributed among the three preweakening patterns 22 so that each preweakening pattern 22 has to perform a pivot motion in a reduced degree. The buckling stress per preweakening pattern is therefore reduced. This is particularly advantageous given relatively thick and/or stiff sheets.

In FIG. 28, five preweakening patterns 22 are provided which partly lie within the edges 18a, 18b and partly to the right of the edge 18b in the direction of the usable area of the sheet 12. Here too, when turning over the sheet 12 the entire deflection angle is distributed among several preweakening patterns 22. The elastic binding device 20, e.g. an elastic band within the edges 18a and 18b, is arranged in the area of these preweakening patterns 22 and holds sheets 12 lying on top of one another together.

FIG. 29 shows another modification in which three binding preweakening patterns 22 are provided which partly lie within the edges 18a, 18b and are partly arranged to the left of the edge 18a in an edge section 25 in the direction of the edge 24. In this embodiment, too, in which the elastic binding device 20 is arranged in the area of the preweakening patterns 22, this binding device 20 holds stacked sheets 12 together. When opening-up such sheets 12 to the right of the edge 18b, the binding device 20 or, respectively, the elastic band within the edges 18a and 18b is stretched to an increased degree as a result of the deflection at the preweakening patterns 22, which is far to the left, so that a greater restoring force acts on the sheets 12 than in the case when the preweakening patterns 22 are arranged further to the right in FIG. 29. In the non-opened state of the book product 10, the sheets 12 are thus held together in an increased manner by the force of the binding device 20 and an opening up is counteracted. In contrast thereto, the short sheet sections 25 of the sheets 12 to the left of the edge 18a can be opened up relatively easily as a result of the preweakening patterns 22 located thereat. On these sheet sections 25, for example, brief information, e.g. titles, can be provided, which belong to the respective sheet 12. By paging through the short sheet sections 25, a quick overview over the sheets 12 contained in the book product 10 can be gained.

In the examples according to FIGS. 27 to 29, each time several preweakening patterns 22 are shown, e.g. three or five. Of course, also only two, four or more preweakening patterns 22 can be provided. It can be advantageous to arrange a preweakening pattern 22 adjacent to the projected edge 18b, i.e. almost congruent with the edge 18b of the binding groove 18 and to provide further preweakening patterns 22 further to the right thereof. When opening up the sheet 12, the binding device 20 is then only stretched to a minimum.

If only one single preweakening pattern 22 is used, then it can be arranged between the edges 18a, 18b, i.e. below the elastic binding device 20. Another modification provides to arrange the single preweakening pattern 22 adjacent to the projected edge 18b or in another modification spaced to the right of the edge 18b.

FIGS. 30 to 32 show a further embodiment of a sheet 12. This sheet 12 has a double-layer structure in its usable area 130. The upper layer includes slots 132, 134, 136, 138. Insertion sheets 140, 142, 144, and 146 belong to the sheet 12, which insertion sheets each have a fold line 148 and define an edge section 150 that can be folded over. These edge sections 150 are adapted to the slots 132 to 138 in their length and width, can be inserted into them and be held thereat between the two layers in the manner of a pocket. FIG. 31 shows the condition of the sheet 12, in which the edge sections 150 are inserted into the slots. The projecting sections of the insertion sheets 140 to 146 can be folded on top of one another so that the sheet 12 has a flat structure in the folded state.

FIG. 32 shows the arrangement in a top view. The sections 150 are inserted into the slots 132 to 138 in the direction of the arrows drawn in and are folded over along the fold lines 148. The fold lines 148 can be designed in the manner of the preweakening patterns 22. The insertion sheets 140 to 146 can be designed like the sheets 12 with preweakening patterns 22 illustrated in the preceding Figures (e.g. as illustrated in FIG. 10). They can be received both by the slots 132 to 138 of the sheet 12 or the binding device 20 of the book product 10. Also given different formats, the insertion sheets 140 to 146 can then be removed from a book product 10 and inserted into the sheet 12 according to FIG. 30 or, vice versa, be removed from the sheet 12 and inserted into the binding device 20 of the same book product.

### LIST OF REFERENCE SIGNS

10 book product
12 sheets
14 upper book cover
16 lower book cover
18 binding groove
18a,18b edges
20 binding device
21 lateral edge
22 binding preweakening line
23 lateral edge
24 edge
25 edge section
26 folding preweakening line
28 section
30 binding section
32 usable area
36 insertion element
38 further folding preweakening line
40 edge section
42 transparent sheet
46 spacer
48 double adhesive film
50 sheet with spacer
52 usable sheet
54 spacer
56 drill hole
58 pin
60 sheet
62 usable area
64 double adhesive film
66 protecting film
68 sheet
70 separating sheet
72 sheet
74 section
76 pocket
78 recessed grip
80 material
82 sheet
84 sheet of white paper
86 sheet with pocket
88 pocket
90 recessed grip
92 sheet with pocket
94 sheet with section
96 section
100 spine
102 sheet as electronic paper
104 usable area
106 spacer
108 chip
110 battery
112 spacer
114 contact
116 connector
118 USB stick
120 postcard
122 address area
124 postage stamp area
126 front usable area
130 usable area
132 to
138 slots
140 to
146 insertion sheets
148 fold line
150 edge section

1. Book product comprising a plurality of sheets, wherein
each sheet is provided with at least one binding preweakening pattern along at least one side parallel to the edge between straight lateral edges of the sheet;
the binding preweakening patterns of sheets lying on top of one another are aligned with one another; and
an elastic binding device is arranged in the in area of the binding preweakening patterns, the elastic binding device holding the sheets together.

2.-7. (canceled)

8. Book product according to claim 1, wherein at least one of an upper cover sheet and a lower cover sheet have at least one of a recess or and a projecting structure receiving the elastic binding device within edges.

9. Book product according to claim 8, wherein the elastic binding device comprises at least one of an elastic band, a rubber band and several rubber bands.

10. Book product according to claim 1, wherein a spine is inserted in the area of the elastic binding device.

11.-19. (canceled)

20. Book product according to claim 1, wherein at least one preweakening pattern is arranged at one of the positions adjacent to one projected edge of a book cover; within protected edges of the book covers; and at a distance of a projected edge of a book cover.

21.-24. (canceled)

25. Sheet for insertion in a book product comprising a plurality of sheets, wherein
each sheet of the book product is provided with at least one binding preweakening pattern along at least one side parallel to the edge between straight lateral edges of the sheet;
the binding preweakening patterns of sheets lying on top of one another are aligned with one another; and
an elastic binding device is arranged in the area of the binding preweakening patterns, the elastic binding device holding the sheets together; wherein
the sheet for insertion is provided with at least one binding preweakening pattern along at least one side parallel to the edge between straight lateral edges of the sheet.

26. Sheet according to claim 25, wherein the sheet comprises at least one folding preweakening pattern extending in parallel to the binding preweakening pattern between the binding preweakening pattern and an adjacent edge, along which folding preweakening pattern the section between the folding preweakening pattern and the edge can be at least one of folded over and glued to the sheet.

27. (canceled)

28. Sheet according to claim 26, wherein at least one additional sheet is provided which can be glued in together with an edge section and the sheet.

29. Sheet according to claim 25, wherein the sheet has a further folding preweakening pattern at a side parallel to the edge opposite to the binding preweakening pattern, along which folding preweakening pattern the edge section between the further folding preweakening pattern and the associated edge can be at least one of folded over and glued in together with an additional sheet.

30.-34. (canceled)

35. Sheet according to claim 25, wherein a pocket is provided in a usable area of the sheet.

36. Sheet according to claim 25, wherein the sheet comprises several usable sheets in the form of a booklet.

37. Sheet according to claim 25, wherein the sheet is formed as a postcard which can be sent via different national postal systems.

38. (canceled)

39. Sheet according to claim 25, wherein the sheet comprises electronic paper as a usable surface.

40.-46. (canceled)

47. Sheet according to claim 25, wherein the sheet is provided in a usable area of the sheet with a double adhesive film and a removable protecting film.

48. Sheet according to claim 35, wherein the pocket is diagonally cut so that objects inserted into the pocket are partly visible.
